(19) United States
(12) Patent Application Publication
(10) Pub. No.: US 2025/0084888 A1
(43) Pub. Date: Mar. 13, 2025

(54) SCREW WITH A HOLE-FORMING TIP

(71) Applicant: EJOT SE & CO. KG, Bad Berleburg (DE)

(72) Inventor: HELMUT STOLL, Duesseldorf (DE)

(21) Appl. No.: 18/727,134

(22) PCT Filed: Jan. 12, 2023
(86) PCT No.: PCT/EP2023/050658

§ 371 Date: Jul. 8, 2024

(30) Foreign Application Priority Data
Jan. 12, 2022 (DE) 10 2022 100 651.4

(51) Int. Cl. F16B 25/00

(52) U.S. Cl. CPC F16B 25/0015; F16B 25/0073; F16B 25/0084

(57) ABSTRACT

A screw incorporates a shaft which transitions into a tip that tapers from the bearing area of the shaft, and terminates at a foremost tip. At least two edges are formed on the tip by a recess thereof, wherein a first edge is formed in the screw-in rotational direction, and a second edge is formed in the opposite direction. The edges are connected via a surface, with a cross-section having a contour line (K). An intersection curve(S) of the screw center plane (ME) is produced by the surface, wherein the distance (A) between the intersection curve(S) and the screw center axis increases from the foremost tip until the distance corresponds to half of the core diameter. An intersection point (A1) of the intersection curve(S), arranged at a distance of D_{K}/4 to the screw center axis, has a length (L), which is greater than D_{K}/3, to the closest intersection point (A2) in the longitudinal direction of the screw at a distance of D_{K}/2 to the screw center axis. An edge angle (alpha) forming the tangent (T) at the first edge (20) together with the contour line (K) increases over the length (L) as the distance between the intersection curve(S) and the center axis (MA) increases.

This application is a national stage application filed under 35 U.S.C 371 of International Application No. PCT Application No. PCT/EP2023/050658 filed Jan. 12, 2023, which claims priority to German Patent Application No. 10 2022 100 651.4 filed Jan. 12, 2022. The disclosures of the above-referenced applications are incorporated herein by reference in their entireties. The invention relates to a screw with a hole-forming tip, in particular for screwing into a porous material, in particular into wood.

Wood screws installed in a timber structure without pre-drilling may result in wood splitting as the hole is being cut by the screw. This can happen because chips produced by the hole-forming process can lead to local compaction, which increases the radial forces generated during the screwing-in process. Such a splitting effect also occurs when using screws having a threaded tip, because a pre-tension is built up in the material that is displaced by the volume of the installed screw as the latter is being screwed in, which leads to a splitting effect in a fibrous material such as wood.

Various approaches for anchoring a screw in timber that are aimed at reducing the splitting tendency of the wood are known in the prior art.

DE 20 2007 018 179 U1, for example, discloses a screw for anchoring in wood and having a scraper groove over its tip, which favors immediate gripping of the thread in the wood and, on the other hand, is intended to prevent wood splitting.

EP 1 903 224 A2 discloses a screw having an eccentric tip provided with a recess, with two lateral cutting edges being connected via scraping surfaces. The scraping surfaces taper off at the head end of the tip—at the transition to the shaft—in a plane that is at an acute angle to the normal of the screw axis. The inclined transition allows material removed by the cutting tip to emerge from the recess in the cutting tip. This reduces the tendency of the wood to split during the screwing-in process.

A screw for self-tapping into wood is to be created which further reduces the splitting effect during screwing in as compared to the prior-art screws. This is accompanied by a reduction in torque during the screwing-in process, which torque can be taken as a measure of the radial forces acting to cause the splitting.

This object is accomplished by the characterizing features of claim 1 in conjunction with the features of its preamble.

The dependent claims relate to advantageous further embodiments of the invention.

The invention is based on the realization that the splitting effect can be reduced, especially for softer woods that have a rather low bulk density, in that the wood matrix can be plastically deformed locally and does not have to be cut or compressed.

In a known manner, the screw of the present invention features a shaft having its core diameter in its bearing area. The shaft transitions into a tip. The tip tapers starting from the bearing part of the shaft and terminates at a foremost tip, which foremost tip lies on the screw center axis. The screw has a thread for screwing into a component in a screw-in direction of rotation, with the thread extending up to the tip. Preferably, some sections of the thread extend into the front area of the tip, in particular into the foremost tip.

At least two edges are formed at the tip by a recess in the screw, namely a first edge, which grips first, in particular in a displacing manner, as the screw is being screwed in, and a second edge, which acts subsequently, in particular in a supporting manner, which edges are arranged in and against the screw-in direction of rotation, resp. Hence, in the screw-in direction of rotation of the screw, the first edge is located at the transition from the lateral surface of the screw to the recess, and, as a result, the area adjacent to the edge of a surface formed by the recess essentially points in the screw-in direction of rotation. The second edge is located on the screw body against the screw-in direction of rotation in the transition from the lateral surface to the recess, so that the area of the surface formed by the recess adjacent to the edge points against the direction of rotation. The edges can also extend into the bearing area, in particular into the cylindrical part of the shaft. Furthermore, a screw center plane is defined on the screw, with the edges being arranged on either side of the screw center plane. The screw center plane includes the screw center axis and is located in particular centrally between the first edge and the second edge. Preferably, when viewed in cross-section, the screw center plane bisects the respective lines that connect the two edges with the screw center axis. The two edges are connected to one another via a surface.

In its cross-section, the surface has a contour line which is preferably a straight or convex contour. Beyond the tip, the edges lie in the envelope contour of the tip. The distance of the edge from the screw centerline corresponds to the radius of the tip in the corresponding cross-section, with the remaining contour line being at a smaller distance from the screw centerline.

In its bearing area, in which the thread has its nominal diameter, the screw has a core diameter D_{K}, which core diameter is defined as the diameter of the enveloping cylinder of the screw core. For a cylindrical root of the thread, the enveloping cylinder is identical to the screw core.

The screw center plane between the two edges intersects the surface, resulting in an intersection curve in the axial direction. The center plane of the screw intersects the contour line, particularly in the middle.

The invention provides for the distance of the intersection curve from the screw center axis in the direction of the screw head, starting from the tip until the cylindrical part of the shaft is reached, to increase at least until this distance corresponds to half the core diameter.

According to the invention, along the intersection curve, the axial distance with the length L, from the intersection point with the distance D_{K}/2 from the screw center axis to the nearest intersection point with the distance D_{K}/4, is greater than D_{K}/3.

An edge angle is formed at the first edge, which is defined between the contour line and the shell surface of the screw.

In the screw of the present invention, the edge angle formed on the first edge, which is defined between the contour line and the tangent on the lateral surface, continues to increase slightly in the direction of the screw head. As a result, the increasing edge angle leads to an increasing outward displacement of the material, especially the wood. On the one hand, this displacement results in increased localized plastic deformation of the surrounding base material in the circumferential direction and to an increasing displacement to the outside of material cut off by the tip. In this way, the tip does not perform a cutting function over the entire length of its edges. The further away the intersection point of the intersection curve assigned to the respective cross-sectional plane is from the screw center axis, the greater will be the forces generated by the edge that are directed outwards against the direction of screwing. This allows a sufficiently high surface pressure to be generated, resulting in a plastic deformation of the base material to such an extent that a channel is created that corresponds to the core diameter of the screw, which significantly reduces the restoring forces of the base material.

According to the invention, as a result of the high local displacement pressure generated in this way, the matrix of the base material in this area is not elastically compressed over a large area, but only in a small area, which makes for better plastic deformation. Plastic deformation of the edge area is advantageous in that the volume required for the screw body can be created in the material in this way and yet the preload in the matrix of the material can be reduced due to the reduction in the restoring forces.

In this way, continuous material displacement in the sense of local plastic deformation during hole formation is achieved by means of the tip, in particular in the sense of collapsing the pore walls. The splitting effect in the material is reduced accordingly, which is also accompanied by a low insertion torque, as the restoring forces of the material are minimized by the plastic deformation.

In another advantageous embodiment of the invention, the distance of the intersection points along the intersection curve from the screw center axis increases continuously from at least half the axial length of the tip in the direction of the screw head. By continuously increasing the distance, a smooth transition from a potentially cutting behavior to a plastically deforming and chip-displacing behavior of the tip is achieved. This results in a successively increasing displacement effect in this direction via the tip and, if necessary, the bearing area of the shaft adjacent to the tip. In particular, the continuous increase in the distance between the intersection points of the intersection curve extends at least over an axial length that is greater than the core diameter D_{K}.

The function of this continuous increase is essentially concave. This can be achieved by sections of linear areas with different gradients and/or by hyperbolic and/or elliptical areas.

If the surface has a straight contour line, the tip and, if applicable, the bearing area of the shaft, viewed in the normal plane to the screw axis, is recessed by a circular segment. The circular segment has a height. The height can correspond at most to the tip radius or the bearing area radius in the same normal plane. Viewed in the axial direction from the foremost tip, the resulting curvature of the intersection curve is formed according to the function of the decrease in tip radius.

The advantage of the rectilinear shape is that what is removed from the base material by an initial cutting behavior, if necessary, can be transported unhindered from the entire recessed volume of the screw tip starting from the second edge over the surface against the screw insertion direction towards the first edge from where it is then introduced into the porous base material, which contributes to increasing the edge pressure and supports the plastic deformation of the porous matrix.

Alternatively, the surface can also be convex, for example over two surfaces in the cross-sectional shape of a circular sector, in particular with an obtuse external angle. The intersection point and/or the surfaces can be more or less rounded.

Particularly in the case of a straight contour line, the height of the cut-out circular segment decreases accordingly along the intersection curve, in the direction of the head, until the cut-out circular segment ends in the cylindrical part of the shaft and thus disappears. Similarly, a recess shaped like a circular sector is also reduced.

Furthermore, the invention may provide for the intersection curve in the region in which it is spaced half the core diameter D_{K} from the screw center axis to have a slope such that the tangent at this point forms an exit angle of less than 45° with the screw center axis. As a result, the separated material can be discharged easily.

In yet another preferred embodiment of the invention, the intersection curve starts in the front area of the tip close to the center axis. In particular, the distance there is less than 25%, in particular less than 15%, in particular less than or equal to 10%, in particular less than or equal to 5%, of the core diameter.

The design of the hole formation area and of the tip is preferably chosen such that, at least in the area of the intersection curve in which it is located at a distance of between 0.4×D_{K} and 0.5×D_{K} from the screw center axis, the intersection curve lies in the bearing area and a displacement effect of the removed material is obtained there both in the outward displacement direction and in the longitudinal direction in the direction of the head. Owing to the resulting displacement direction, the material separated in the front area of the tip can be better discharged from the tip area.

In another preferred embodiment of the invention, the intersection curve increases in the area of the continuous increase along a radius. If the intersection curve corresponds to a radius, the recess of the screw tip can be produced easily using a disk milling cutter.

In particular, the intersection curve extends in such a way that it reaches the distance D_{K}/2 from the center axis at a point which lies in the bearing area of the shaft, in particular the cylindrical part, following the tip in the direction of the head. There, the screw core has its full core diameter D_{K}, which means that the edge is able to act in this area to form the screw hole.

In a further embodiment of the invention, the thread has a pitch, in which the distance between the point at which the intersection curve reaches the distance D_{K}/2 from the center axis and the transition of the thread tip to the bearing area corresponds to at least this pitch. This allows the material to be displaced to the core diameter over an entire revolution.

In yet another preferred embodiment of the invention, the distance between the point at which the intersection curve in the bearing area reaches the distance D_{K}2 from the center axis and the transition of the thread tip to the bearing area can be up to 10 times in particular, more preferably up to 8 times, more preferably up to 6 times, more preferably up to 2.5 times the thread pitch or up to approx. 1 times the thread pitch. The ratio of this distance to the thread pitch is referred to as the action ratio. Particularly with an action ratio of more than 2.5, i.e. with a distance of more than 2.5 times the pitch in the bearing area, in the preferably cylindrical part of the screw, the result is that removed material accumulated at the tip can be efficiently displaced into the base material, thus further reducing the splitting effect. This allows a screw connection to be made at a smaller distance from the edge of a wood component without any splicing.

A smaller thread pitch increases the action of an axial edge section per axial length section of the base material, especially with a high action ratio, because the edge section acts on the base material more often per length section, since the feed of the screw per revolution is lower due to the lower thread pitch. Increasing the number of revolutions per feed results in an improved displacement per length section, which can further reduce the splitting effect.

The number of such edge actions per length section can be determined accordingly by the action ratio. Adjusting this action ratio thus also allows the nominal screw diameter to be taken into account. This means that the action ratio can be increased with increasing nominal diameter.

Preferably, the action ratio is more than 2.5 and less than 8. An action ratio range between 3 and 6 has proven to be particularly effective. This action ratio takes into account the requirements for the shortest possible overall thread length and a screw connection that is as splice-free as possible.

Additional advantages, features and possible applications of the present invention will be apparent from the description which follows, in which reference is made to the embodiments illustrated in the drawings.

In the drawings,

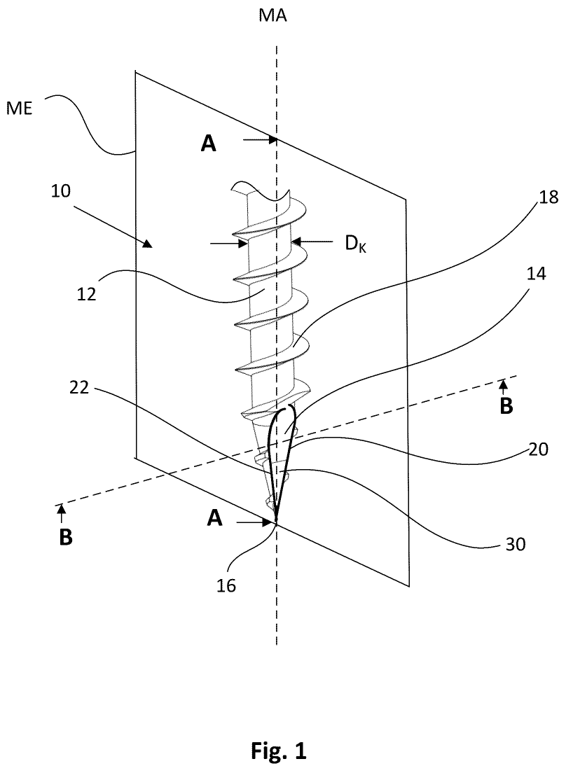

FIG. 1 is a perspective view of a detail of a screw according to the invention;

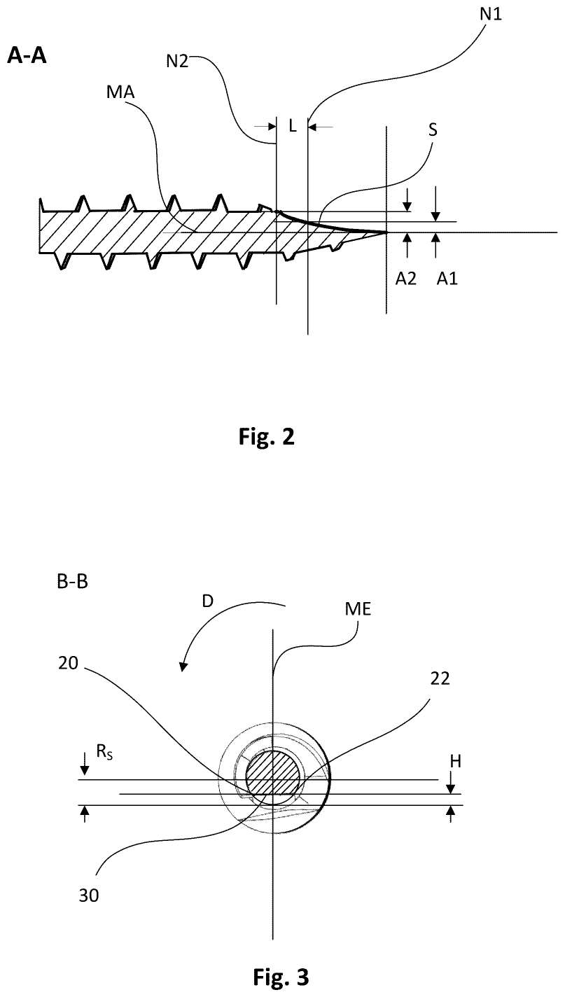

FIG. 2 is a sectional view taken along lines A-A of FIG. 1;

FIG. 3 is a sectional view taken along lines B-B of FIG. 1;

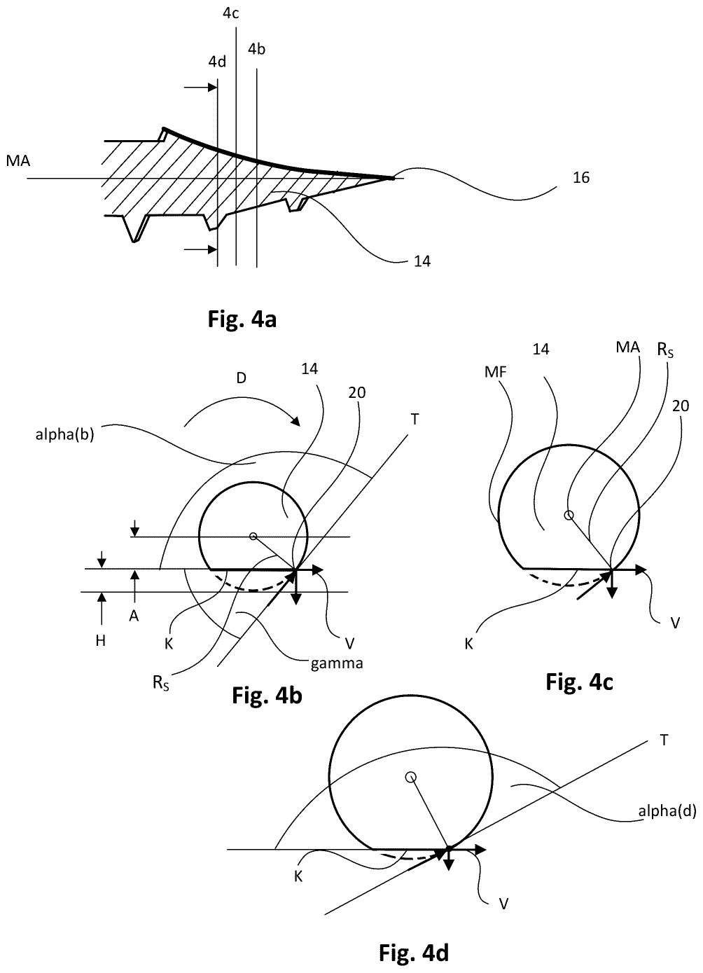

FIG. 4a is an enlarged view of the tip of FIG. 1;

FIG. 4b is a schematic view of a section at position 4b of FIG. 4a;

FIG. 4c is a schematic view of a section at position 4c of FIG. 4a;

FIG. 4d is a schematic view of a section at position 4d of FIG. 4a;

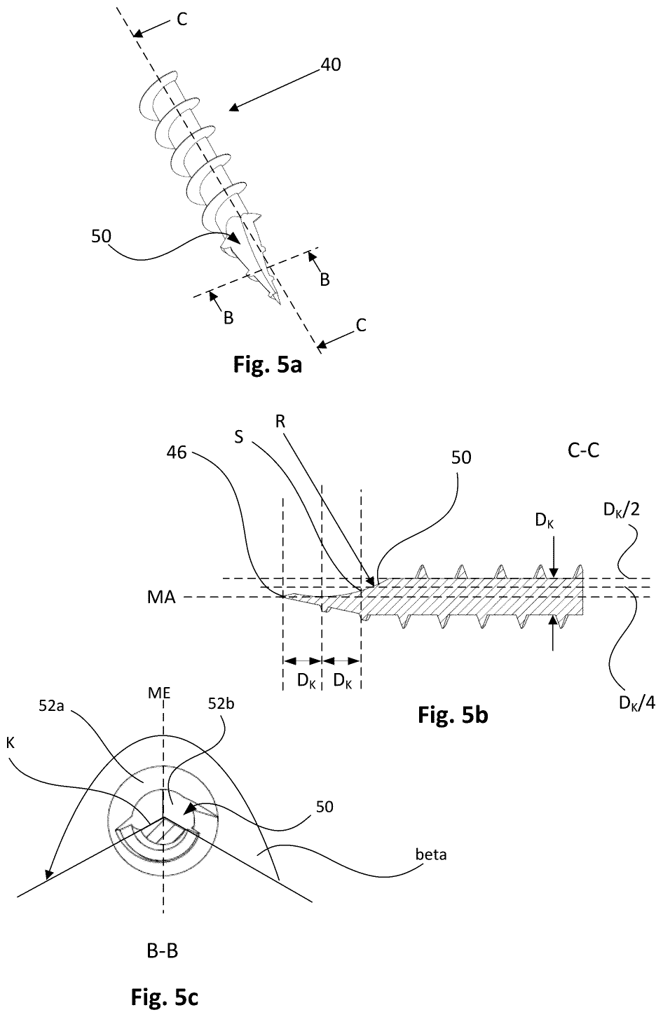

FIG. 5a is a perspective view of a screw having an intersection curve similar to FIG. 1;

FIG. 5b is a sectional view taken along lines C-C of a screw according to FIG. 5a showing the intersection curve;

FIG. 5c is a sectional view taken along lines B-B of FIG. 5a;

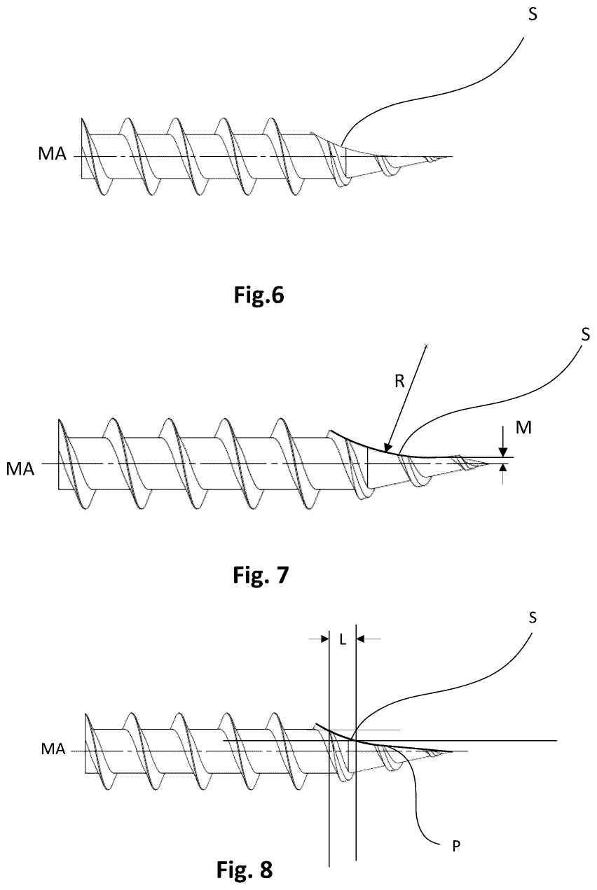

FIG. 6 is a sectional view of another embodiment of the invention also showing the intersection curve;

FIG. 7 is a sectional view of another embodiment of the invention also showing the intersection curve;

FIG. 8 is a sectional view of another embodiment of the invention also showing the intersection curve;

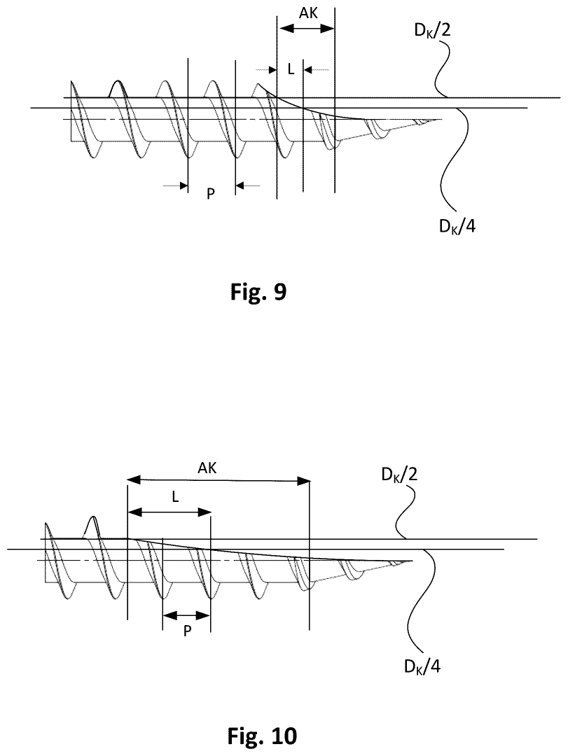

FIG. 9 is a side view of another embodiment of the invention, and

FIG. 10 is a side view of another embodiment of the invention.

FIG. 1 is a perspective view of a detail of a screw 10 according to the invention. The screw 10 comprises a shaft 12 which transitions from a cylindrical area into a tip 14 that terminates at a front tip 16. The shaft 12 has a thread 18 formed on it that extends up to the tip 14. The shaft 12 has a core diameter D_{K}.

The tip 14 has a hole-forming area which is designed in such a way that a first edge 20 is formed on the screw tip 14 in the direction of rotation and a second edge 22 is formed in the transition from the lateral surface to the recess in the opposite direction to the direction of rotation. This would allow wood fibers to still be removed from the base material during the rotation of the screw at the first edge 20, at least in its area closer to the tip.

Further seen in FIG. 1 is the center plane ME, which includes the center axis MA and which is located centrally between the two edges 20, 22 of the screw tip 14. The edges 20, 22 are shown in bold for greater clarity.

A surface 30 extends between the two edges 20, 22, which is intersected by the center plane ME and thus forms an intersection curve as shown in FIG. 2. In the present embodiment, the surface 30 has a straight contour, as seen in FIGS. 4b to 4d.

FIG. 2 is a view of a section of the screw of FIG. 1 taken at the center plane ME as well as of the intersection curve S resulting in the present embodiment. The distance A of the intersection points of the intersection curve S from the center axis MA increases, starting from the foremost tip 16 to the cylindrical bearing part of the shaft 12, at least until the distance A of the intersection curve S corresponds to half the core diameter D_{K} of the cylindrical part of the shaft 12, which is indicated in this Figure by the distance A2 and forms the intersection point N2 with the normal plane in the axial direction.

As shown, at N2, A2 the edges 20, 22 break through the cylindrical envelope of the, in particular cylindrical, bearing area of the shaft, which essentially represents the end of the hole-forming region. The length L between the corresponding points of intersection with the normal plane, namely N1, where the distance of the intersection curve is D_{K}/4, and N2, where the distance is D_{K}/2, is greater than ⅓ D_{K}, with D_{K} being the core diameter in the bearing area.

The gentle taper of the hole forming area thus achieved according to the invention leads to increasing displacement of the material of the wood matrix, resulting in a plastic deformation of the wood matrix in the hole-forming area. This can reduce the splitting effect when screwing in the screw.

In the present embodiment, this thus results in a smooth transition from the recess of the tip to the bearing part of the shaft for the hole-forming area of the tip.

FIG. 3 is a section through the tip 14 in the normal plane to the screw axis B-B. The surface 30 extends from the first edge 20 which lies in the direction of rotation D over the screw center plane ME to the edge 22 lying against the direction of rotation D. The surface 30 connects the edges in cross-section in a straight line orthogonal to the center plane ME.

FIG. 4a is an enlarged detail of the sectional view of FIG. 2, showing the positions 4b to 4d of the schematic sections in the normal plane.

The views of FIGS. 4b to 4d show the schematic cross-section of the tip 14, without thread, in the direction of the head (not shown) of the screw. The distance A of the intersection curve S from the screw center axis MA increases over the axial distance from the foremost tip 16. The tip radius R_{S} also increases over the axial distance from the foremost tip. The tip radius R_{S} is the radius in the respective cross-sectional plane which the tip 14 has in its non-recessed circular segment with a straight contour line K.

The ratio of the height H of the cut-out segment (indicated by a dashed line) to the tip radius R_{S} in the normal plane decreases with increasing axial distance from the foremost tip 16 until the height H of the cut-out circular segment is zero and the radius corresponds to half the core diameter D_{K} of the shaft in the bearing area. Following the intersection curve contour in the direction of the head, the recess can also be continued outside the screw core, so that the thread can also be recessed accordingly.

Increasing the distance from the screw center axis and simultaneously reducing the ratio of the height H of the cut-out circular segment to the tip radius R_{S} results in a successive reduction of the cutting angle gamma, i.e. the angle between the surface and the tangent at the edge 20. This results in an increasingly displacing effect of the edge 20 lying in the direction of rotation. This generates an increasingly greater surface pressure at the edge 20 in the direction of the outwardly directed force component V, which forms an obtuse angle, namely the apex angle to the edge angle, with the tangent T to the circumference of the lateral surface MF. This results in an increasingly displacing effect in the direction of the head, which leads to continuous plastic deformation of the base material and to a displacement into the matrix of the base material of any material that may accumulate due to the cutting behavior of the front area of the tip.

This allows any material that has been removed by the edge 20 up to the position of the cut 4b by the tip 14 to also be pressed out of the hole formation area and into the wood matrix with increasing distance from the foremost tip 16. FIG. 4b shows an example of the edge angle alpha(b) defined between the tangent to the screw core in its non-recessed area and the contour line.

The edge angle alpha shown increases from alpha(b) in FIG. 4b to alpha(d) in FIG. 4d. The increase in the edge angle alpha, accompanied by the reduction in the cutting angle gamma, results in an increasing displacing effect owing to the increase in the outwardly directed force component V.

By way of example, the sections of FIGS. 4b to 4d illustrate how the outwardly directed displacement force component V increases with increasing distance from the foremost tip.

This creates a screw tip having a reduced splitting effect, because the matrix of the base material is plastically deformed to a much greater extent compared to the prior art screw tips. Even in the case of pre-drilling in the front area of the tip, the cut-off material is also immediately displaced by the increasing outward deformation force.

FIG. 5a to FIG. 5c are views of a screw 40 according to the invention, the edges of which are connected to one another via a convex surface 50 in the manner of a sector-like contour line K, and the angle of intersection of the two surface areas 52a, 52b is more than 180°, namely 225° in the present case. FIG. 5a is the perspective view.

FIG. 5b shows the sectional view taken along lines C-C of the screw of FIG. 5a at the center plane ME, which bisects the surface areas 52a, 52b. As is seen in this view, the intersection curve S, starting from the foremost tip 46, may first decrease in its distance from the center axis MA and then increase again as it progresses. From about the distance D_{K} from the foremost tip, the intersection curve then extends along a radius R. The length L at which the distance of the intersection curve S increases from D_{K}/4 to D_{K}/2 is slightly greater than D_{K}/3.

FIG. 5c shows a cross-section taken along lines B-B of FIG. 5b, in which the angle beta of 225° between the surface areas 52a, 52b can clearly be seen. This design achieves a greater displacement effect relative to the cutting effect of the edge.

Illustrated in FIG. 6 to FIG. 8 are further embodiments with different courses of the intersection curve S, with the cross-sectional shape of the tips essentially corresponding to the circular segments illustrated in FIGS. 4b to 4d.

FIG. 6 shows an embodiment according to which, up to about half of the axial extent of the tip, there is no increase in the distance of the intersection curve S from the center axis MA. Rather, the surfaces in this area are at the height of the center axis. From about half of the axial extent of the tip, starting from the foremost tip, the distance of the intersection curve S from the center axis MA begins to increase over about 1.5×D_{K} until the distance corresponds to half the core diameter D_{K}.

FIG. 7 shows an intersection curve S that extends along a circular radius. In this view, the point with the smallest distance M is about D_{K}/8 from the center line.

FIG. 8 shows a further embodiment according to the invention with the corresponding intersection curve S.

In the present embodiment, this curve extends from the foremost tip to approximately half the tip length with a linear increase in distance A and then curves concavely, preferably along a radius. The axial distance between the nearest point of intersection of the intersection curve S with the normal plane, for which the distance from the center axis MA is equal to D_{K}/2 and D_{K}/4, represents the length L, which is greater than D_{K}/2. The greater the length L, the smoother the taper in the bearing area of the screw shaft can be. However, this reduces the bearing capacity for the same thread length.

Owing to its front area, the screw tip can be adapted to different applications, whereby the transition to the bearing part of the shaft tapers off smoothly, which in turn results in a displacement of the material that was cut off at the front area of the tip.

FIG. 9 shows an embodiment in which the recess has an essentially straight contour line and the recess extends slightly more than the pitch P into the cylindrical part of the shaft. As a result, the area of the edge that lies on the core diameter D_{K} has the distance D_{K}/2 from the screw center axis and acts on the base material at least over the feed of one complete revolution of the screw, thereby improving the hole-forming effect. The length L increases within the distance of the intersection curve from D_{K}/4 to D_{K}/2 and in the present design lies completely within the bearing area of the shaft. This means that the distance AK from the transition of the screw tip into the bearing area to the exit point where the recess terminates, i.e. the point at which the distance to the center axis is D_{K}/2, is greater than the length L. The action ratio AK/P is less than 2.5. This allows a longer range of fully load-bearing threads to be achieved in the bearing area for the same overall thread length.

FIG. 10 shows a further embodiment in which the point, also known as the exit point, at which the intersection curve reaches the distance D_{K}/2 from the center axis, is located in the cylindrical bearing area of the shaft. In this example, the distance AK is approximately 4 times the thread pitch P. The action ratio AK/P is therefore approximately 4. With such a design, a further reduction in the splitting effect can be achieved with the same base material, as on the one hand the increased action ratio can result in increased compaction of the base material, and on the other hand the longer recess means that cut-out material can be discharged more easily from the channel formed. This means that screw connections can be made in areas close to the edge without splicing. In particular, in this embodiment, the point at which the intersection curve reaches D_{K}/4 is also located in the bearing area of the screw, with the result that AK is also significantly larger than L in this embodiment.

1. A screw comprising a shaft which has a core diameter and which transitions into a tip, which tip tapers starting from the bearing area of the shaft and which tip terminates at a foremost tip, said foremost tip lying on the screw center axis (MA), which screw has a thread for screwing the screw to a component in a screw-in direction of rotation and the thread extends up to the tip, wherein furthermore a screw center plane (ME) is defined and at least two edges are formed at the tip by a recess at least of the tip, wherein a first edge lies in the screw-in direction of rotation and a second edge lies counter to the screw-in direction of rotation, wherein the first edge and the second edge lie on both sides of the screw center plane (ME), wherein the two edges are connected via a surface, wherein the surface has a contour line (K) in its cross-sections, an intersection curve(S) of the screw center plane (ME), which lies between the edges, with the surface is obtained, with the distance (A) of the intersection curve(S) from the screw center axis (MA), as viewed from the foremost tip, increasing at least until this distance corresponds to half the core diameter D_{K}, with the intersection point (A1) of the intersection curve(S), which is D_{K}/4 away from the screw center axis, is a length (L) in the longitudinal direction of the screw away from the nearest intersection point (A2) with the distance D_{K}/2 from the screw center axis, the length (L) being greater than D_{K}/3, wherein over the length (L) in this region an edge angle (alpha), which is defined between the tangent (T) to the screw shell surface on the first edge and the contour line (K), also increases with increasing distance of the intersection curve(S) from the center axis (MA).

2. The screw according to claim 1, wherein the length (L) is greater than D_{K}/2.

3. The screw according to claim 1, wherein the contour line (K) is essentially rectilinear or convex.

4. The screw according to claim 1, wherein the tip has a basic shape, in particular a conical basic shape, so that, viewed in cross-section, the edges on the side opposite the contour line are connected in a circle.

5. The screw according to claim 1, wherein the distance (A) of the intersection curve(S) increases continuously in the direction of the head from at least half of the screw tip.

6. The screw according to claim 1, wherein the continuous increase in the distance (A) of the intersection curve(S) extends at least over an axial length of once the core diameter D_{K}.

7. The screw according to claim 1, wherein, starting from the foremost tip, the distance of the edges from the center plane increases in the direction of the head.

8. Screw according to claim 1, wherein the intersection curve in the region of the distance (A2) of D_{K}/2 has such a slope that the tangent forms an exit angle with the screw center line (MA) which is less than 45°.

9. The screw according to claim 1, wherein the distance (A) of the intersection curve(S) from the center axis at the end facing the foremost tip is less than or equal to 25%, in particular less than or equal to 15%, in particular less than or equal to 10%, in particular less than or equal to 5%, of the core diameter D_{K}.

10. The screw according to claim 1, wherein in the distance range (A) of the intersection curve(S) from 0.4 D_{K} to 0.5 D_{K}, the intersection curve(S) is in the bearing region where there is a displacement effect of the removed material both in the outward displacement direction (V) and in the longitudinal direction in the direction of the head.

11. The screw according to claim 2, wherein the area of continuous increase of the distance (A) of the intersection curve(S) follows a circular radius.

12. The screw according to claim 1, wherein, in continuation of the intersection curve(S) beyond the radial distance D_{K}/2, the thread in the bearing region of the shaft is also correspondingly recessed.

13. The screw according to claim 1, wherein the intersection curve(S) reaches the distance D_{K}/2 from the center axis at a point which lies in the cylindrical part of the shaft.

14. The screw according to claim 1, wherein the thread has a pitch (P), and the distance (AK) from the transition of the screw tip into the bearing region to the point at which the intersection curve(S) reaches the distance D_{K}/2 from the center axis (MA) is up to 10 times, in particular up to 8 times, the pitch (P), in particular up to 6 times, in particular up to 2.5 times, in particular approximately 1 times, the thread pitch.

15. The screw according to claim 14, wherein the resulting action ratio of distance (AK) to thread pitch (P) is between 3 and 6, with the distance (AK) being between the transition of the screw tip into the bearing area and the point at which the intersection curve(S) reaches the distance D_{K}/2 from the center axis (MA).
